(19) United States
(12) Patent Application Publication
(10) Pub. No.: US 2014/0337057 A1
(43) Pub. Date: Nov. 13, 2014

(54) CAUSE-OF-DEATH ESTIMATING APPARATUS AND CAUSE-OF-DEATH ESTIMATING METHOD

(71) Applicants: KABUSHIKI KAISHA TOSHIBA, Minato-Ku (JP); TOSHIBA MEDICAL SYSTEMS CORPORATION, Otawara-Shi (JP)

(72) Inventors: Mariko SHIBATA, Nasushiobara-Shi (JP); Shigeharu OHYU, Yaita-Shi (JP); Yasuo SAKURAI, Nasushiobara-Shi (JP); Keisuke HASHIMOTO, Nasushiobara-Shi (JP)

(73) Assignees: KABUSHIKI KAISHA TOSHIBA, Minato-Ku (JP); TOSHIBA MEDICAL SYSTEMS CORPORATION, Otawara-Shi (JP)

(21) Appl. No.: 14/446,423

(22) Filed: Jul. 30, 2014

Related U.S. Application Data
(63) Continuation of application No. PCT/JP2013/077942, filed on Oct. 15, 2013.

(30) Foreign Application Priority Data
Oct. 16, 2012 (JP) 2012-229199

(51) Int. Cl. G06F 19/00

(52) U.S. Cl. CPC G06F 19/322; G06F 19/321
USPC 705/3

(57) ABSTRACT

A cause-of-death estimating apparatus includes a diagnostic information acquiring section, a disease/wound history acquiring section and a cause-of-death estimating section. The diagnostic information acquiring section is configured to acquire diagnostic information on image data on a body. The disease/wound history acquiring section is configured to acquire a diagnosis/treatment history of the body before death of the body. The cause-of-death estimating section is configured to estimate a direct cause of death of the body and an original cause thereof based on the acquired diagnostic information and the acquired diagnosis/treatment history.

### CROSS-REFERENCE TO RELATED APPLICATION

This application is a Continuation Application of No. PCT/JP2013/77942, filed on Oct. 15, 2013, and the PCT application is based upon and claims the benefit of priority from Japanese Patent Application No. 2012-229199, filed on Oct. 16, 2012, the entire contents of which is incorporated herein by reference.

### FIELD

An embodiment of the present invention relates to a cause-of-death estimating apparatus and a cause-of-death estimating method.

### BACKGROUND

The Ministry of Health, Labour and Welfare issued the “Manual to fill in a death certificate (post-mortem examination report), 2012”. According to the manual to fill in a death certificate, cause-of-death statistics is useful as an important basic administrative material related to health, medical care and welfare of people and is a valuable material in various fields including medical research.

Therefore, the cause of death entered in the death certificate (post-mortem examination report) used as a material for preparing cause-of-death statistics has to be accurate. In Japan, however, in most cases, the cause of death is determined only by visual check of the body surface even if the person seems to have died an unnatural death. In view of this, reports from the Ministry of Health, Labour and Welfare imply that the cause-of-death statistics may not be accurate.

Thus, the “investigative commission on application of autopsy imaging to diagnosis of cause of death” organized by the Ministry of Health, Labour and Welfare and other agencies has performed a wide variety of reviews and eventually concluded that an autopsy imaging (Ai) center is provided in each prefecture. If Ai becomes widely available and common practice, epidemiological researches as to the frequency of occurrences of severe diseases or wounds or the mortality thereof can probably be more accurately conducted.

As a means for diagnosing a cause of death, a medical image processing apparatus has been disclosed which acquires image data on a body and detects an abnormal shadow by analyzing the image data according to an algorithm for detecting an abnormal shadow in each part of the body.

However, it is pointed out that, if body transportation or information exchange between a medical institution and an Ai center is complicated, it can be ambiguous where the responsibility for preparing the death certificate lies. Furthermore, from the viewpoint of epidemiological researches, it is important to determine not only the direct cause of death but also the name of a disease or wound that caused the cause of death. Therefore, it is also implied that the diagnosis result obtained by analyzing the image data on the dead body at the Ai center alone is insufficient.

That is, it is probably difficult to prepare an accurate and specific death certificate, perform epidemiological researches and prepare cause-of-death statistics only by determining the cause of death based on the image diagnosis result obtained by analyzing the image data on the dead body.

### BRIEF DESCRIPTION OF THE DRAWINGS

FIG. 1 is a schematic diagram showing an example of a schematic configuration of a death certificate creation supporting system having a cause-of-death estimating apparatus according to an embodiment;

FIG. 2 is a sequence diagram schematically showing an operation of the whole of the death certificate creation supporting system having an Ai center terminal according to the embodiment;

FIG. 3 is a functional block diagram showing functions of the Ai center terminal according to the embodiment;

FIG. 4 is a diagram for illustrating an example of a related disease/wound list stored in a disease/wound database according to the embodiment;

FIG. 5 is a block diagram showing a hardware configuration of the Ai center terminal according to the embodiment;

FIG. 6 is a flowchart showing a cause-of-death estimation process performed by the death certificate creation supporting system including the Ai center terminal according to the embodiment in which the Ai center terminal performs cause-of-death estimation;

FIG. 7 is a diagram for illustrating diagnostic information related to a cause of death based on image data acquired by a diagnostic information acquiring section (FIG. 3) of the Ai center terminal according to the embodiment;

FIG. 8 is a diagram for illustrating an example of an electronic medical chart in the case where a disease/wound history acquiring section (FIG. 3) of the Ai center terminal according to the embodiment acquires information on the electronic medical chart from a terminal in a hospital;

FIG. 9 is a diagram for illustrating an example of an electronic medical chart in the case where the disease/wound history acquiring section (FIG. 3) of the Ai center terminal according to the embodiment acquires information on the electronic medical chart from a terminal in a hospital;

FIG. 10 is a diagram for illustrating a disease/wound history registered with the hospital acquired from the terminal in the hospital by the disease/wound history acquiring section (FIG. 3) of the Ai center terminal according to the embodiment;

FIG. 11 is a diagram for illustrating a disease/wound history registered with the hospital acquired from the terminal in the hospital by the disease/wound history acquiring section (FIG. 3) of the Ai center terminal according to the embodiment;

FIG. 12 is a diagram for illustrating a result of extraction of cause-of-death candidates related to the cause of death based on the disease/wound histories and the diagnostic information by a cause-of-death candidate retrieving section of the Ai center terminal according to the embodiment;

FIG. 13 is a diagram for illustrating relationship diagrams with which the cause-of-death candidate retrieving section of the Ai center terminal according to the embodiment groups cause-of-death candidates related to the cause of death based on the related disease/wound list;

FIG. 14 is a diagram for illustrating how a cause-of-death estimating section of the Ai center terminal according to the embodiment rearranges the cause-of-death candidates in chronological order and estimates a direct cause of death of a patient and an original cause thereof from the cause-of-death candidates rearranged in chronological order; and

FIG. 15 is a diagram for illustrating a death certificate template used for creating a death certificate of the patient filled in with the estimated direct cause of death of the patient and original cause thereof by a death certificate template transmitting section of the Ai center terminal according to the embodiment.

### DETAILED DESCRIPTION

A present embodiments provide a cause-of-death estimating apparatus including: a diagnostic information acquiring section configured to acquire diagnostic information on image data on a body; a disease/wound history acquiring section configured to acquire a diagnosis/treatment history of the body before death of the body; and a cause-of-death estimating section configured to estimate a direct cause of death of the body and an original cause thereof based on the acquired diagnostic information and the acquired diagnosis/treatment history.

As a result, the cause-of-death estimating apparatus according to the embodiment can accurately and specifically estimate a cause of death.

In the following, a death certificate creation supporting system provided with the cause-of-death estimating apparatus according to this embodiment will be described with reference to the drawings.

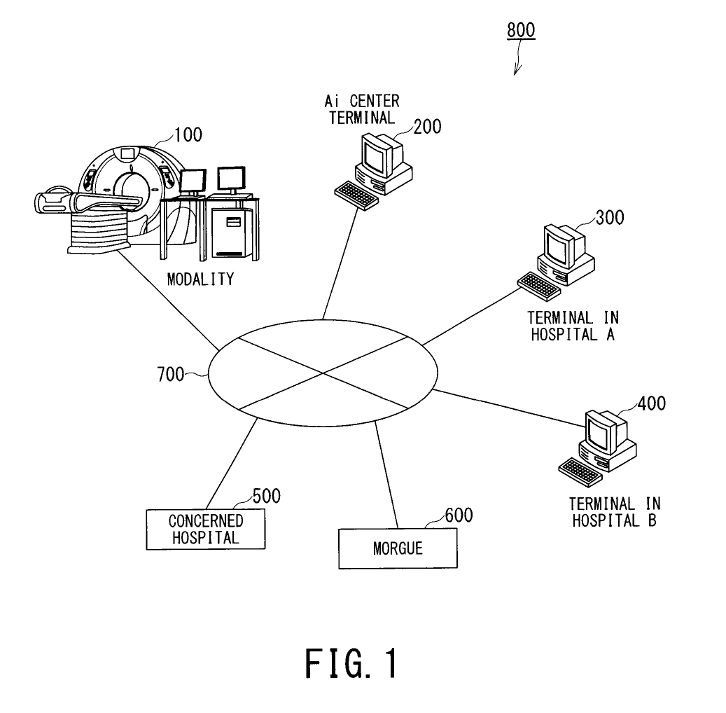

FIG. 1 is a schematic diagram showing an example of a schematic configuration of a death certificate creation supporting system 800 provided with the cause-of-death estimating apparatus according to this embodiment.

As shown in FIG. 1, the death certificate creation supporting system 800 comprises a modality 100, an autopsy imaging (Ai) center terminal (cause-of-death estimating apparatus) 200, a terminal 300 in a hospital A, a terminal 400 in a hospital B, a concerned hospital 500 and a network 700, for example.

Modality means a medical system name used for classification of apparatuses (imaging apparatuses) for imaging a subject. Examples of the modality 100 includes an X-ray computed tomography (CT) apparatus, a magnetic resonance imaging (MRI) apparatus, an ultrasonic diagnostic apparatus and a nuclear medical diagnostic apparatus. The X-ray CT apparatus is an imaging apparatus that scans an object with a radiation or the like and processes the scan result with a computer. The MRI apparatus is an apparatus that uses a magnetic field and a radio wave to produce images of the inside of a body of a subject. The ultrasonic diagnostic apparatus is a diagnostic imaging apparatus that applies an ultrasonic wave to a subject and visualizes the echo of the ultrasonic wave. The nuclear medical diagnostic apparatus is a diagnostic imaging apparatus that extracts a tomographic image of the body of a subject including a particular focus by labelling a reagent dispensed in the body of the subject and accumulated in the focus with a radioisotope and detecting γ-rays emitted from the reagent with a detector, such as a scintillation camera. In this embodiment, any of such imaging apparatuses is used as the modality 100 to examine the body of the patient immediately after the death of the patient.

The Ai center terminal 200 is a terminal that is a part of the cause-of-death estimating apparatus and estimates a cause of death from a result of examination of the body performed using the modality 100. Ai is an abbreviation of autopsy imaging, which is a diagnostic method of diagnosing a cause of death by performing X-ray CT examination or MRI examination immediately after the death of the patient, for example.

The Ai center terminal 200 according to this embodiment has a function of estimating a direct cause of death of the patient and an original cause thereof and a function of creating a death certificate template after the direct cause of death of the patient and the original cause thereof are estimated when the result of Ai examination (image diagnosis) is registered. A medical institution including the Ai center terminal 200 and the modality 100 is regarded as an Ai center (not shown). A specific configuration of the Ai center terminal 200 will be described later.

The direct cause of death of the patient herein refers to the name of a disease or wound that is the direct cause of death. The original cause thereof herein refers to the name of a disease or wound that is the cause of the direct cause of death.

The terminal 300 in the hospital A is a patient information terminal in which patient information on a patient who has ever received treatment at the hospital A is registered. The patient information herein includes basic information on the patient, such as address and name, and a diagnosis/treatment record that shows a disease/wound history of the patient (including a diagnosis/treatment recording, an operation record, examination data and image diagnosis data), for example.

The terminal 400 in the hospital B is a patient information terminal in which patient information on a patient who has ever received treatment at the hospital B is registered.

In this embodiment, the concerned hospital 500 is a medical institution where the death of the patient is certified. If the patient has been hospitalized and received treatment in the concerned hospital 500 for a long time under the name of a particular disease or wound and died as a result of the disease or wound, the cause of death is obvious. In that case, a doctor in charge of the patient's case in the concerned hospital checks the time of death, refers to an electronic medical chart of the patient and creates a death certificate by filling in the death certificate template with required information.

However, it is difficult for the doctor to identify the cause of death only by visual check of the body surface of a patient if it is suspected that a medical error occurred during treatment, if the patient had a plurality of diseases, if the patient fell unconscious outside the hospital and was carried to the hospital by an ambulance, or if the patient was killed in a natural disaster, an accident or an incident. In those cases, the concerned hospital 500 sends the body of the patient to the Ai center and requests the Ai center to determine the cause of death. If the concerned hospital 500 has image data about the patient, the concerned hospital 500 also transmits the image data and chart information on the patient to the Ai center terminal 200.

A morgue 600 is a place where the body of the patient whose death has been pronounced at the concerned hospital 500 is laid in state. The morgue 600 is an optional component, so that the morgue 600 does not necessarily have to be integrated with the concerned hospital 500 and can be any place where the body can be laid in state.

The network 700 is a network that interconnects terminals and devices connected to the death certificate creation supporting system 800.

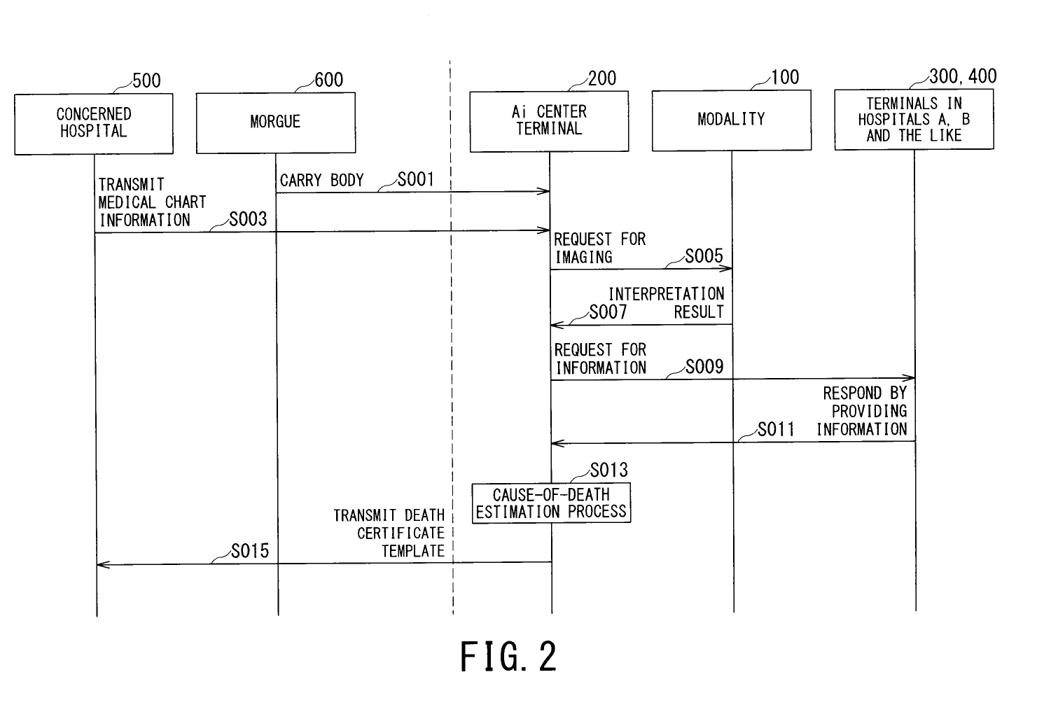

FIG. 2 is a sequence diagram schematically showing an operation of the whole of the death certificate creation supporting system 800 including the Ai center terminal 200 according to this embodiment. In FIG. 2, reference numerals with a prefix S denote steps in the sequence diagram.

The body of the patient whose death was pronounced at the concerned hospital 500 is laid in state in the morgue 600. A wrist band or body bag, which bears the identification (ID) of the concerned hospital 500, the name of the patient, the chart information on the patient or the like, is attached to the body to prevent confusion of patients. The body is then carried from the morgue 600 to the Ai center in which the Ai center terminal 200 is provided (Step S001).

The concerned hospital 500 also sends the chart information on the patient carried to the Ai center or a letter of referral to the Ai center terminal 200 (Step S003).

Once the Ai center receives the body, and the Ai center terminal 200 receives the chart information, the Ai center terminal 200 issues an imaging request to the modality 100 in the Ai center (Step S005). This embodiment is not limited to any particular examination method, and the examination method may be X-ray CT examination or MRI examination.

Once imaging of the body is completed, the modality 100 transmits an imaging result and an interpretation result therefor to the Ai center terminal 200 (Step S007). The modality 100 does not necessarily have to transmit the image of the body and the interpretation result at the same time. The modality 100 may first transmit the image alone to the Ai center terminal 200 and then transmit a result of interpretation of the image with an interpreter (not shown) in the Ai center, such as a computer-assisted diagnostic (CAD) system, to the Ai center terminal 200.

In this embodiment, the presence or absence of a past operation related to the cause of death needs to be added to the death certificate, and information on the process of death needs to be collected and reflected in an epidemiological database. To this end, diagnosis/treatment records, diagnostic images and other medical information (that is, diagnosis/treatment records) about the patient before death created in other medical institutions or examination institutions are collected based on an ID number of the patient, such as the health insurance card number or the national identification number, and the disease/wound histories from those institutions are combined to each other.

More specifically, the Ai center terminal 200 requests the terminal 300 in the hospital A, the terminal 400 in the hospital B and the like to provide the Ai center terminal 200 with information, such as the electronic medical chart, diagnostic images and medical checkup records of the patient (Step S009).

If the terminal 300 in the hospital A and the terminal 400 in the hospital B have any of the electronic medical chart, diagnostic images, medical checkup records of the patient and the like, the terminals respond to the Ai center terminal 200 by providing the information (Step S011). Specifically, if the terminal 300 in the hospital A has an abdominal CT image or an endoscopy result, the terminal 300 in the hospital A transmits the information to the Ai center terminal 200. The image data can be transmitted as electronic data. Part of the image data can be extracted and transmitted to the Ai center terminal 200.

When the terminal 300 in the hospital A or the terminal 400 in the hospital B transmits the disease/wound history or electronic medical chart, an operator may manually enter the disease/wound history, or the ontology, which is a known technique, may be used to extract the disease/wound history from the electronic medical chart based on the semantics and transmit the disease/wound history, for example.

Based on the interpretation result from the modality 100 and the disease/wound history obtained from the terminal 300 in the hospital A or the terminal 400 in the hospital B, the Ai center terminal 200 extracts information necessary to determine the cause of death and to create the death certificate from the information related to the cause of death, and performs a cause-of-death estimation processing (Step S013).

Based on the result of the cause-of-death estimation processing, the Ai center terminal 200 creates the death certificate template and transmits the death certificate template to the requesting concerned hospital 500 (Step S015).

Next, detailed functions of the Ai center terminal 200 according to this embodiment will be described.

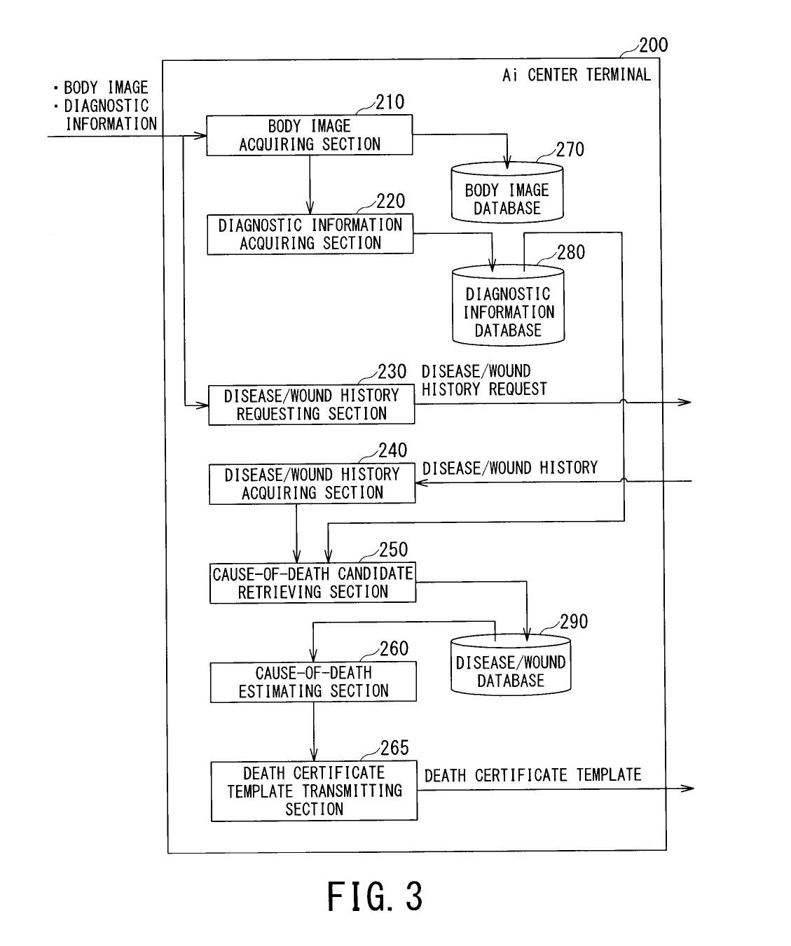

FIG. 3 is a functional block diagram showing functions of the Ai center terminal 200 according to this embodiment.

As shown in FIG. 3, the Ai center terminal 200 comprises a body image acquiring section 210, a diagnostic information acquiring section 220, a disease/wound history requesting section 230, a disease/wound history acquiring section 240, a cause-of-death candidate retrieving section 250, a cause-of-death estimating section 260, a death certificate template transmitting section 265, a body image database 270, a diagnostic information database 280 and a disease/wound database 290, for example.

The body image acquiring section 210 is configured to acquire image data on the body (of the dead patient) imaged by the modality 100. The body image acquiring section 210 is configured to store the acquired image data in the body image database 270.

The diagnostic information acquiring section 220 is configured to acquire diagnostic information based on the body image data (diagnostic information related to the cause of death based on the acquired body image data, for example). More specifically, the diagnostic information acquiring section 220 is configured to acquire the interpretation result for the body image data from the modality 100 and store the interpretation result in the diagnostic information database 280. However, this embodiment is not limited to this configuration, and the diagnostic information acquiring section 220 may acquire diagnostic information related to the cause of death based on the image data acquired by the body image acquiring section 210 and interpreted by a radiologist and store the diagnostic information in the diagnostic information database 280.

The disease/wound history requesting section 230 is configured to request each hospital for a disease/wound history registered in the hospital based on a treatment history related to the body (of the dead patient) before death. For example, the disease/wound history requesting section 230 is configured to inquire the terminal 300 in the hospital A or the terminal 400 in the hospital B over the network 700 and request for the disease/wound history of the patient before death.

The disease/wound history acquiring section 240 is configured to acquire a diagnosis/treatment history of the patient before death from the hospital with which the requested disease/wound history is registered. For example, if a disease/wound history based on the treatment history of the patient is registered in the terminal 300 in the hospital A or the terminal 400 in the hospital B, the disease/wound history acquiring section 240 is configured to acquire the disease/wound history as the diagnosis/treatment history of the patient before death from the terminal 300 in the hospital A or the terminal 400 in the hospital B.

In the case where the disease/wound history acquiring section 240 acquires information on the electronic medical chart from the terminal 300 in the hospital A or the terminal 400 in the hospital B, the disease/wound history acquiring section 240 is configured to extract the names of diseases and wounds, the medical history, the names of examinations and the findings and the like described in the electronic medical chart as the disease/wound history by the ontology technique (word extraction and analysis) and text mining. Text mining is a sort of data mining that is targeted for character strings. For example, text mining is to extract useful information by analyzing data in the electronic medical chart by dividing the data on a word or clause basis and determining the occurrence frequency of each word or clause, the relationship among the words or clauses, the occurrence tendency of each word or clause or the like. If an identification tag, such as the name of a disease or wound, is previously attached to a word in the electronic medical chart, the identification tag can also be used.

The cause-of-death candidate retrieving section 250 is configured to search the disease/wound database 290 in which diseases and wounds are registered based on the acquired disease/wound history and the diagnostic information related to the cause of death of the patient acquired by the diagnostic information acquiring section 220 and retrieves a cause-of-death candidate related to the cause of death according to the degree of severity. In this case, for example, the cause-of-death candidate retrieving section 250 can extract a related disease or wound showing the degree of progress of the disease or wound from the disease/wound database 290 based on the acquired disease/wound history and the diagnostic information, and retrieve a cause-of-death candidate related to the cause of death based on the related disease or wound. An example of a search process in this case will be described below with reference to a drawing.

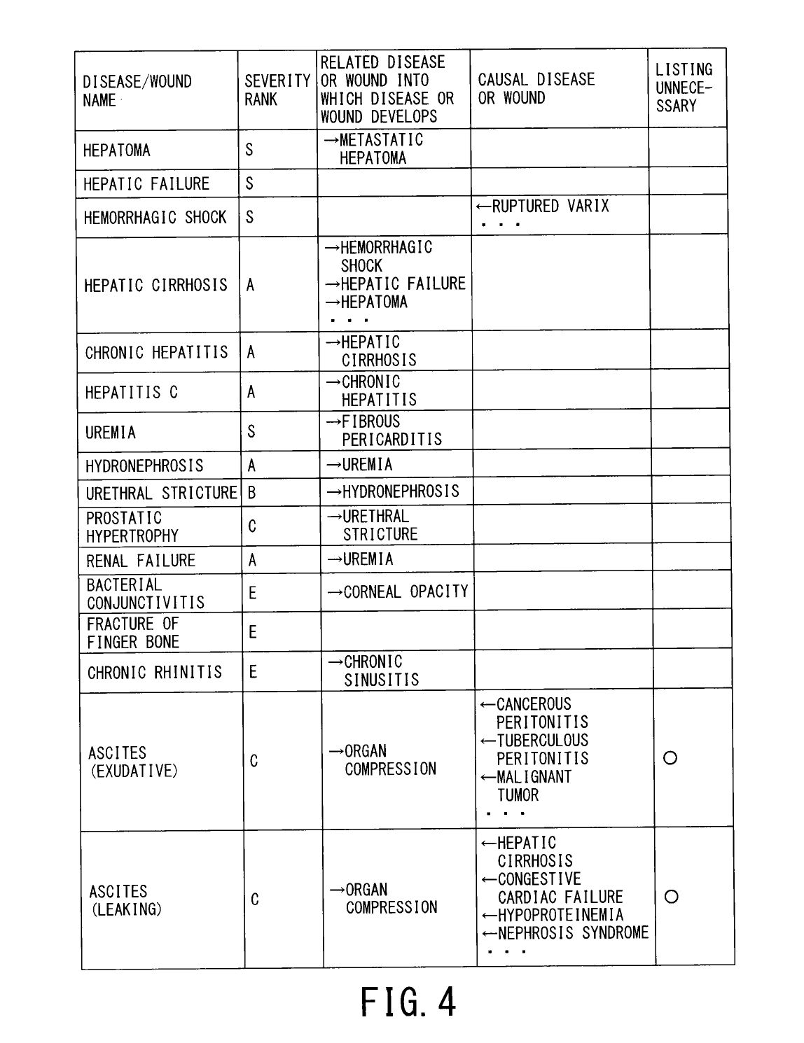

FIG. 4 is a diagram for illustrating an example of a related disease/wound list stored in the disease/wound database 290 according to this embodiment.

As shown in FIG. 4, the related disease/wound list has a “disease/wound name” field, a “severity rank” field, a “related disease or wound into which disease or wound develops” field, a “causal disease or wound” field, and a “listing unnecessary” field.

In the “disease/wound name” field of the related disease/wound list, all the currently known diseases or wounds are registered, such as “hepatoma”, “hepatic failure”, “hemorrhagic shock”, “hepatic cirrhosis”, “chronic hepatitis”, “hepatitis C” and “uremia”.

In the “severity rank” field, the degree of severity of each disease/wound name is entered as the severity rank. Specifically, according to the current standards of medical care, the rank of the highest severity is denoted as an S rank, and in descending order of severity, the S rank, an A rank, a B rank, a C rank, a D rank or an E rank is allocated to each disease or wound.

In the example shown in FIG. 4, hepatoma is classified as the S rank, and hepatic failure is also classified as the S rank. Hepatic cirrhosis is classified as the A rank, and hepatitis C is also classified as the A rank. Ascites is classified as the C rank. In this embodiment, the D rank and the E rank are non-lethal ranks. Diseases or wounds classified as the D rank or E rank are determined to be non-lethal and therefore are not estimated to be a direct cause of death.

In the “related disease or wound into which disease or wound develops” field, the name of a disease or wound into which the disease or wound entered in the “disease/wound name” field can develop is entered. For example, it is shown that hepatoma can develop into metastatic hepatoma and that hepatic cirrhosis can develop into hemorrhagic shock, hepatic failure or hepatoma. Furthermore, it is also shown that chronic hepatitis can develop into hepatic cirrhosis.

In the “causal disease or wound” field, the name of a disease or wound that can cause the disease or wound is entered. For example, as a cause of hemorrhagic shock, ruptured varix is entered. Furthermore, as causes of ascites (exudative), cancerous peritonitis, tuberculous peritonitis and malignant tumor are entered.

The “listing unnecessary” field is intended to indicate that listing of the related disease or wound retrieved by the cause-of-death candidate retrieving section 250 is unnecessary. If a circle is entered in this field, listing of the related disease or wound is not made.

Since a related disease or wound that the disease or wound can develop into can be retrieved from the related disease/wound list, the cause-of-death candidate retrieving section 250 can retrieve a related disease or wound based on the name of a disease or wound and retrieve a cause-of-death candidate based on the severity rank. In addition, based on the related disease/wound list, the cause-of-death candidate retrieving section 250 can also create a relationship diagram of related diseases or wounds, which is a tree diagram showing a relationship among (grouping of) diseases or wounds.

The cause-of-death estimating section 260 is configured to estimate the direct cause of death of the patient and the original cause thereof based on the acquired diagnosis/treatment information and diagnosis/treatment history. For example, the cause-of-death estimating section 260 estimates the direct cause of death of the patient and the original cause thereof based on the causality indicated by the retrieved cause-of-death candidate. More specifically, the cause-of-death estimating section 260 rearranges the retrieved cause-of-death candidates in chronological order and estimates the direct cause of death of the patient and the original cause thereof from the cause-of-death candidates rearranged in chronological order.

The death certificate template transmitting section 265 is configured to transmit the death certificate template used for creating the death certificate of the patient to the outside after the death certificate is filled in with the direct cause of death of the patient and the original cause thereof estimated by the cause-of-death estimating section 260.

The death certificate template transmitting section 265 is configured by default to transmit the death certificate template to the concerned hospital 500. However, this embodiment is not limited to the configuration. For example, the death certificate template may be transmitted to the Ministry of Health, Labour and Welfare that takes cause-of-death statistics or to a police station, the hospital A, the hospital B, a municipality or the like.

Next, a hardware configuration of the Ai center terminal 200 according to this embodiment will be described.

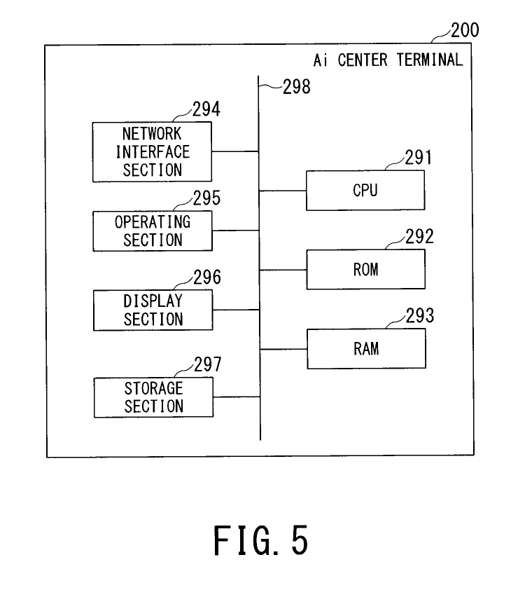

FIG. 5 is a block diagram showing a hardware configuration of the Ai center terminal 200 according to this embodiment.

As shown in FIG. 5, the Ai center terminal 200 comprises a central processing unit (CPU) 291, a read only memory (ROM) 292, a random access memory (RAM) 293, a network interface section 294, an operating section 295, a display section 296, a storage section 297 and the like.

The CPU 291 is configured to load various programs stored in the ROM 292 to the RAM 293 and develop the programs, thereby providing the functions of the programs. The RAM 293 is intended for use as a work area (working memory). The ROM 292 is intended to store various programs. The various programs stored in the ROM 292 include a program for implementing each function of the Ai center terminal 200 shown in FIG. 3.

The network interface section 294 is an interface section through which the Ai center terminal 200 transmits an information request to the terminal 300 in the hospital A or the terminal 400 in the hospital B or acquires medical chart information from the concerned hospital 500 over the network 700.

The operating section 295 comprises an input device or the like that allows an operation for display of the disease/wound history and diagnostic information stored in the databases of the Ai center terminal 200 or for input, edit or registration of a program. Specifically, the operating section 295 is constituted by a keyboard, a mouse or the like.

The display section 296 is a display section on which the interpretation result from the modality 100 or the medical chart information transmitted from the concerned hospital 500 is displayed. The display section 296 is constituted by a liquid crystal display, a monitor or the like.

The storage section 297 is a storage section that forms a storage memory and is constituted by a RAM, a hard disk or the like. In this embodiment, the storage section 297 forms the body image database 270 that stores body image data, the diagnostic information database 280 that stores diagnostic information derived from the image data, or the disease/wound database 290, for example.

As described above, in this embodiment, the storage section 297 forms the body image database 270, the diagnostic information database 280 or the disease/wound database 290, and each function of the Ai center terminal 200 shown in FIG. 3 can be provided by executing a program stored in the ROM 292.

(Cause-of-Death Estimation Process)

Next, a cause-of-death estimation process performed by the death certificate creation supporting system 800 including the Ai center terminal 200 according to this embodiment will be described.

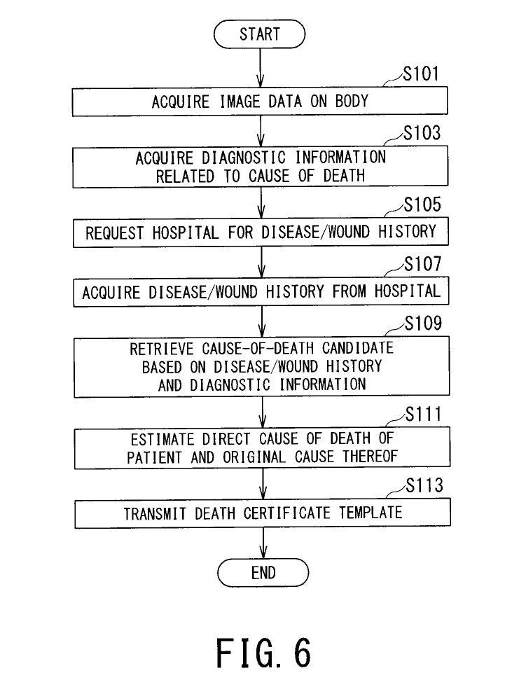

FIG. 6 is a flowchart showing a cause-of-death estimation process performed by the death certificate creation supporting system 800 including the Ai center terminal 200 according to this embodiment in which the Ai center terminal 200 performs cause-of-death estimation. In FIG. 6, reference numerals with a prefix S denote steps in the flowchart.

First, in Step S101, the body image acquiring section 210 (FIG. 3) acquires image data on a body taken by the modality 100. The body image acquiring section 210 then stores the acquired image data in the body image database 270.

In Step S103, the diagnostic information acquiring section 220 (FIG. 3) acquires diagnostic information related to the cause of death based on the acquired body image data. In this case, the diagnostic information acquiring section 220 acquires the interpretation result for the body image data from the modality 100 and stores the interpretation result in the diagnostic information database 280. Alternatively, the diagnostic information acquiring section 220 may acquire diagnostic information related to the cause of death based on the image data acquired by the body image acquiring section 210 and interpreted by a radiologist and store the diagnostic information in the diagnostic information database 280. The diagnostic information to be acquired will be described with reference to a drawing.

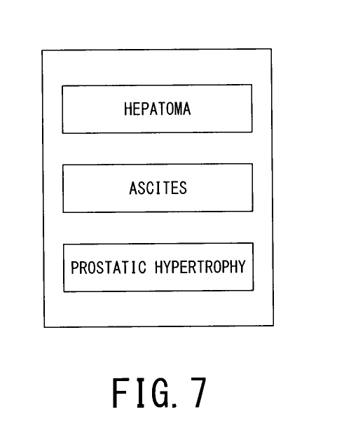

FIG. 7 is a diagram for illustrating diagnostic information related to the cause of death based on the image data acquired by the diagnostic information acquiring section 220 (FIG. 3) of the Ai center terminal 200 according to this embodiment.

As shown in FIG. 7, the diagnostic information includes a disease/wound name “hepatoma”, a finding “ascites” and a disease/wound name “prostatic hypertrophy” as the result of interpretation for the patient by a radiologist at the Ai center. The interpretation result is stored in the diagnostic information database 280 as the diagnostic information.

In Step S105, the disease/wound history requesting section 230 (FIG. 3) requests each hospital for a registered disease/wound history based on the treatment history of the patient before death. For example, the disease/wound history requesting section 230 inquires the terminal 300 in the hospital A or the terminal 400 in the hospital B over the network 700, thereby requesting for the disease/wound history or electronic medical chart of the patient before death.

In Step S107, the disease/wound history acquiring section 240 (FIG. 3) acquires the disease/wound history or electronic medical chart from the hospital with which the requested disease/wound history or electronic medical chart is registered. For example, if a disease/wound history based on the treatment history kept in the hospital A or hospital B is registered, the disease/wound history acquiring section 240 acquires the disease/wound history from the terminal 300 in the hospital A or the terminal 400 in the hospital B.

If the disease/wound history is transmitted from the terminal 300 in the hospital A or the terminal 400 in the hospital B, the disease/wound history acquiring section 240 (FIG. 3) directly acquires the disease/wound history. If information on the electronic medical chart is transmitted from the terminal 300 in the hospital A or the terminal 400 in the hospital B, the disease/wound history acquiring section 240 (FIG. 3) performs text mining of the transmitted information on the electronic medical chart and extracts a disease/wound name, a medical history, an examination name, a finding or the like from the information on the electronic medical chart.

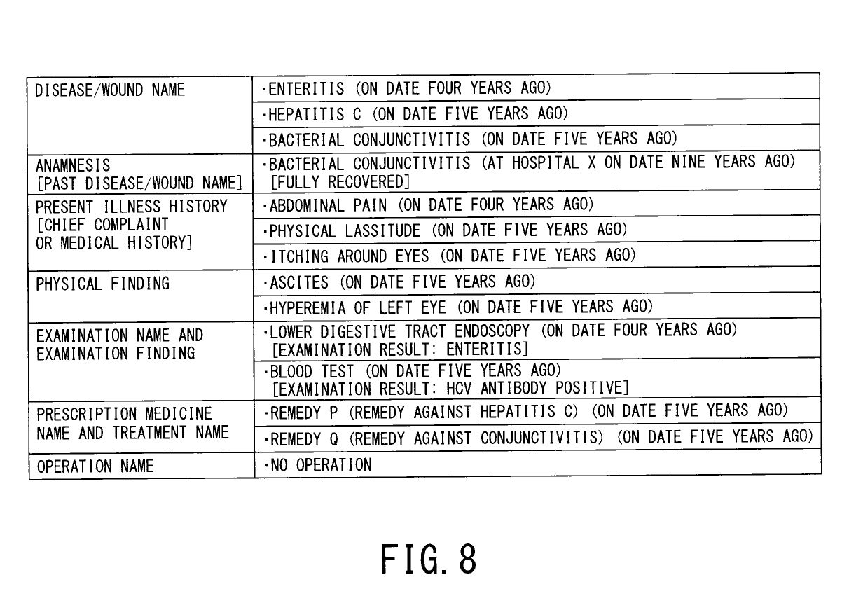

FIG. 8 is a diagram for illustrating an example of the electronic medical chart in the case where the disease/wound history acquiring section 240 (FIG. 3) of the Ai center terminal 200 according to this embodiment acquires information on the electronic medical chart from the terminal 300 in the hospital A.

As shown in FIG. 8, the electronic medical chart includes item fields including a disease/wound name field, an anamnesis [past disease/wound name] field, a present illness history [chief complaint or medical history] field, a physical finding field, an examination name and examination finding field, a prescription medicine name and treatment name field and an operation name field. For example, in the disease/wound name field, it is described that the patient developed enteritis four years ago, that the patient developed hepatitis C five years ago, and that the patient developed bacterial conjunctivitis five years ago.

In the anamnesis [past disease/wound name] field, it is described that the patient fully recovered from bacterial conjunctivitis at a hospital X on a date nine years ago. In the present illness history [chief complaint or medical history] field, it is described that the patient developed abdominal pain four years ago, that the patient complained of physical lassitude five years ago, and that the patient had itching around the eyes five years ago.

In the physical finding field, it is described that the patient developed ascites five years ago and that the patient had hyperemia of the left eye five years ago. In the examination name and examination finding field, it is described that the patient had abdominal pain and received a lower digestive tract endoscopy (small intestine endoscopy) four years ago and that the patient was diagnosed as having enteritis. Furthermore, it is described that the patient received a blood test five years ago and that the patient was HCV antibody positive, which indicates that the patient had been infected with hepatitis C virus.

In the prescription medicine name and treatment name field, it is described that a remedy P, which is a remedy against hepatitis C, was prescribed five years ago and that a remedy Q, which is a remedy against conjunctivitis, was also prescribed five years ago. In the operation name field, it is described that the patient had had no operation.

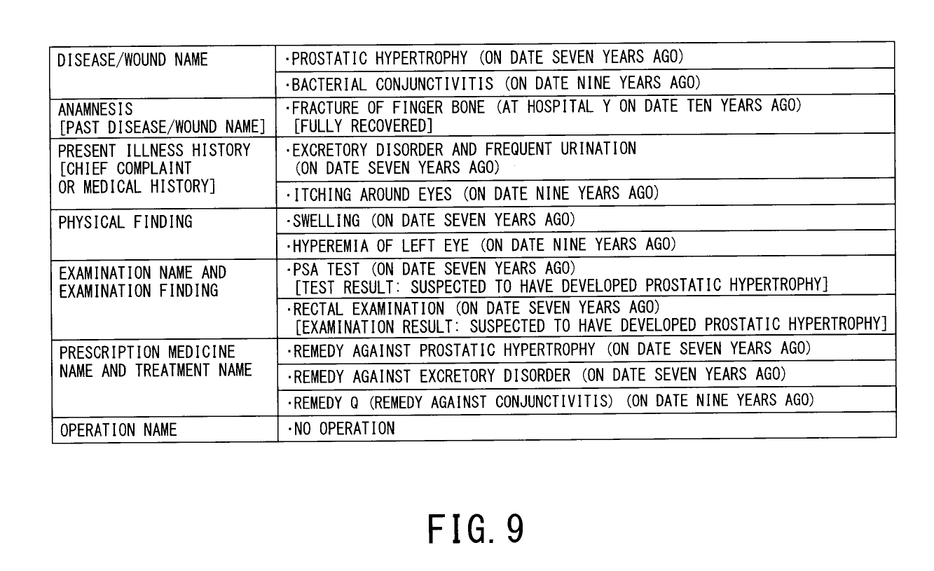

FIG. 9 is a diagram for illustrating an example of the electronic medical chart in the case where the disease/wound history acquiring section 240 (FIG. 3) of the Ai center terminal 200 according to this embodiment acquires information on the electronic medical chart from the terminal 400 in the hospital B.

FIG. 9 shows the same item fields as those in FIG. 8. In the disease/wound name field, it is described that the patient developed prostatic hypertrophy seven years ago and that the patient developed bacterial conjunctivitis nine years ago.

In the anamnesis [past disease/wound name] field, it is described that the patient fully recovered from fracture of a finger bone at a hospital Y on a date ten years ago. In the present illness history [chief complaint or medical history] field, it is described that the patient complained of excretory disorder and frequent urination seven years ago and that the patient had itching around the eyes nine years ago.

In the physical finding field, it is described that the patient had swelling seven years ago and that the patient had hyperemia of the left eye nine years ago. In the examination name and examination finding field, it is described that the patient received a prostate specific antigen (PSA) test and was suspected to have developed prostatic hypertrophy seven years ago and that the patient received rectal examination and suspected to have developed prostatic hypertrophy seven years ago.

In the prescription medicine name and treatment name field, it is described that a remedy against prostatic hypertrophy was prescribed seven years ago, that a remedy against excretory disorder was prescribed seven years ago and that the remedy Q, which is a remedy against conjunctivitis, was prescribed nine years ago. In the operation name field, it is described that the patient had had no operation.

The disease/wound history acquiring section 240 can perform text mining of the electronic medical chart acquired from the terminal 300 in the hospital A and text mining of the electronic medical chart acquired from the terminal 400 in the hospital B, thereby extracting the disease/wound history from each of the electronic medical charts from the hospitals.

Next, a disease/wound history stored in the terminal 300 in the hospital A and a disease/wound history stored in the terminal 400 in the hospital B will be described with reference to drawings.

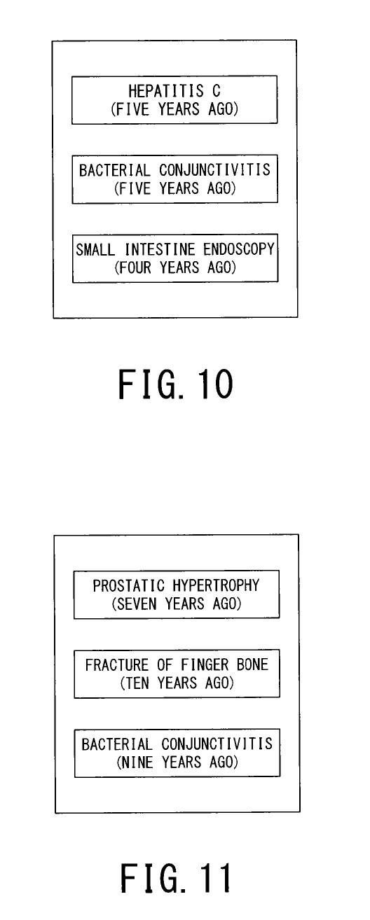

FIG. 10 is a diagram for illustrating a disease/wound history registered with the hospital A acquired from the terminal 300 in the hospital A by the disease/wound history acquiring section 240 (FIG. 3) of the Ai center terminal 200 according to this embodiment.

As shown in FIG. 10, the disease/wound history recorded at the hospital A includes “hepatitis C (five years ago)”, “bacterial conjunctivitis (five years ago)” and “small intestine endoscopy (four years ago)”. The disease/wound history acquiring section 240 acquires the disease/wound history.

FIG. 11 is a diagram for illustrating a disease/wound history registered with the hospital B acquired from the terminal 400 in the hospital B by the disease/wound history acquiring section 240 (FIG. 3) of the Ai center terminal 200 according to this embodiment.

As shown in FIG. 11, the disease/wound history recorded at the hospital B includes “prostatic hypertrophy (seven years ago)”, “fracture of a finger bone (ten years ago)” and “bacterial conjunctivitis (nine years ago)”. The disease/wound history acquiring section 240 acquires the disease/wound history.

In Step S109, the cause-of-death candidate retrieving section 250 searches the disease/wound database 290 in which diseases and wounds are registered based on the disease/wound histories acquired from the terminal 300 in the hospital A and the terminal 400 in the hospital B and the diagnostic information acquired by the diagnostic information acquiring section 220 and retrieves a cause-of-death candidate related to the cause of death according to the degree of severity.

More specifically, the cause-of-death candidate retrieving section 250 searches the related disease/wound list (FIG. 4) stored in the disease/wound database 290 based on the diagnostic information (FIG. 7) stored in the diagnostic information database 280 and retrieves a cause-of-death candidate related to the cause of death according to the degree of severity.

For example, the cause-of-death candidate retrieving section 250 is configured to retrieve diseases and wounds classified as the C and higher severity ranks. “Hepatoma”, “ascites” and “prostatic hypertrophy” included in the diagnostic information shown in FIG. 7 are all extracted as cause-of-death candidates, because “hepatoma” is classified as the S rank, and “ascites” and “prostatic hypertrophy” are classified as the C rank.

Furthermore, the cause-of-death candidate retrieving section 250 searches the related disease/wound list (FIG. 4) stored in the disease/wound database 290 based on the disease/wound history (FIG. 10) from the terminal 300 in the hospital A acquired by the disease/wound history acquiring section 240 and retrieves a cause-of-death candidate related to the cause of death according to the degree of severity. As with the above description, the cause-of-death candidate retrieving section 250 is configured to retrieve diseases and wounds classified as the C and higher severity ranks. Of “hepatitis C (five years ago)”, “bacterial conjunctivitis (five years ago)” and “small intestine endoscopy (four years ago)” included in the disease/wound history shown in FIG. 10, “hepatitis C” is extracted as a cause-of-death candidate, because “hepatitis C (five years ago)” is classified as the A rank, “bacterial conjunctivitis (five years ago)” is classified as the E rank, and “small intestine endoscopy (four years ago)” is a test name (neither a disease nor a wound).

Furthermore, the cause-of-death candidate retrieving section 250 searches the related disease/wound list (FIG. 4) stored in the disease/wound database 290 based on the disease/wound history (FIG. 11) from the terminal 400 in the hospital B acquired by the disease/wound history acquiring section 240 and retrieves a cause-of-death candidate related to the cause of death according to the degree of severity. As with the above description, the cause-of-death candidate retrieving section 250 is configured to retrieves diseases and wounds classified as the C and higher severity ranks. Of “prostatic hypertrophy (seven years ago)”, “fracture of a finger bone (ten years ago)” and “bacterial conjunctivitis (nine years ago)” included in the disease/wound history shown in FIG. 11, “prostatic hypertrophy (seven years ago)” is extracted as a cause-of-death candidate, because “prostatic hypertrophy (seven years ago)” is classified as the C rank, “fracture of a finger bone (ten years ago)” and “bacterial conjunctivitis (nine years ago)” are classified as the E rank.

However, “bacterial conjunctivitis” may be extracted as a cause-of-death candidate, because bacterial conjunctivitis may imply “immunodeficiency” if the disease/wound histories from a plurality of medical institutions, the hospitals A and B in this example, include bacterial conjunctivitis. Such a disease or wound can be extracted by performing text mining of the disease/wound histories or electronic medical chart from a plurality of medical institutions to count the number of extractions of the disease or wound name.

More specifically, the significance rank of a disease or wound name that frequently occurs and the name of another disease or wound (immunodeficiency, for example) that is inferred from the frequently occurring disease or wound name can be registered in the disease/wound database, and the another disease or wound can be extracted as a cause-of-death candidate. Alternatively, a disease or wound name that frequently occurs in the disease/wound history from one medical institution may be extracted in the same manner by text mining.

In extraction of a related disease or wound as a cause-of-death candidate, if information about an infectious disease, gas poisoning or the like is available from the concerned hospital 500, for example, the information can be taken into account in extracting a cause-of-death candidate. In that case, the information about an infectious disease, gas poisoning or the like is important in order to prevent staff or the like of the Ai center from being accidentally infected or exposed to a toxic gas.

As described above, in Step S109, the cause-of-death candidate retrieving section 250 extracts a disease or wound that is a cause-of-death candidate according to the severity rank provided in the related disease/wound list stored in the disease/wound database 290. The extracted cause-of-death candidates are “hepatoma”, “prostatic hypertrophy (seven years ago and Ai)”, “hepatitis C” and “ascites”.

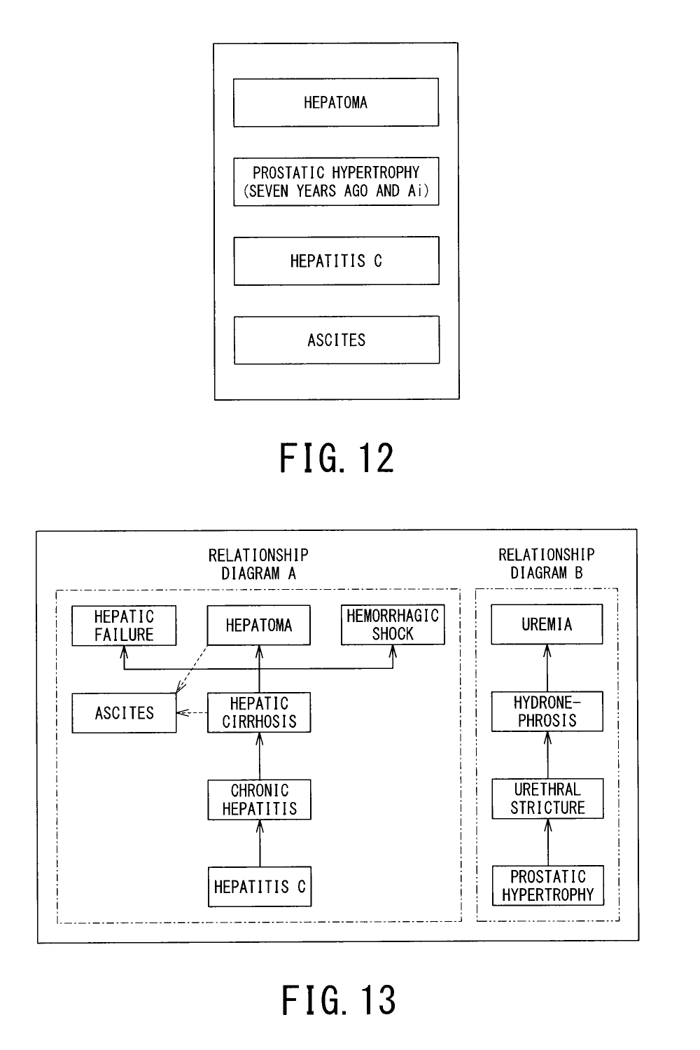

FIG. 12 is a diagram for illustrating a result of extraction of cause-of-death candidates related to the cause of death based on the disease/wound histories and the diagnostic information by the cause-of-death candidate retrieving section 250 according to this embodiment.

As shown in FIG. 12, the cause-of-death candidate retrieving section 250 extracts “hepatoma”, “prostatic hypertrophy (seven years ago and Ai)”, “hepatitis C” and “ascites” as cause-of-death candidates based on the disease/wound histories from the terminal 300 in the hospital A and the terminal 400 in the hospital B and the diagnostic information of the Ai center terminal 200. The method of extracting the cause-of-death candidates is not limited to the method described above. For example, a known technique, such as the ontology technique or text mining, can be used to infer cause-of-death candidates from an electronic medical chart, or a specific tag that identifies a disease or wound name may be used to extract a disease/wound history from information on an electronic medical chart.

Furthermore, the cause-of-death candidate retrieving section 250 refers to the related disease/wound list stored in the disease/wound database 290 and creates a relationship diagram of related diseases or wounds, which is a tree diagram showing a relationship among diseases or wounds. The relationship diagram is a tree diagram that groups commonly known diseases or wounds in the course of progression thereof. The diagram allows the cause-of-death candidate retrieving section 250 to group the extracted cause-of-death candidates, “hepatoma”, “prostatic hypertrophy (seven years ago and Ai)”, “hepatitis C” and “ascites” as shown in the relationship diagrams described below.

FIG. 13 is a diagram for illustrating relationship diagrams with which the cause-of-death candidate retrieving section 250 of the Ai center terminal 200 according to this embodiment groups cause-of-death candidates related to the cause of death based on the related disease/wound list.

As shown in FIG. 13, the cause-of-death candidate retrieving section 250 (FIG. 3) classifies the diseases or wounds that are cause-of-death candidates into a group that belongs to a relationship diagram A including “hepatoma”, “hepatitis C” and “ascites” and a group that belongs to a relationship diagram B including “prostatic hypertrophy”.

The relationship diagram A shown in FIG. 13 shows that hepatitis C develops into chronic hepatitis or hepatic cirrhosis. Furthermore, it is considered that possible outcomes of hepatic cirrhosis include hepatic failure, hepatoma and hemorrhagic shock. Furthermore, ascites is a possible outcome of progression of hepatoma or hepatic cirrhosis.

The relationship diagram B shown in FIG. 13 shows that prostatic hypertrophy develops into urethral stricture, hydronephrosis or uremia. The diseases or wounds shown in the relationship diagrams A and B correspond to the related diseases or wounds in the related disease/wound list.

As described above, the cause-of-death candidate retrieving section 250 searches the disease/wound database 290 in which diseases and wounds are registered based on the disease/wound histories acquired from the terminal 300 in the hospital A and the terminal 400 in the hospital B and the diagnostic information acquired by the diagnostic information acquiring section 220 and extracts (retrieves) a cause-of-death candidate related to the cause of death according to the degree of severity.

The Ai center terminal 200 according to this embodiment may display the relationship diagrams for the related diseases or wounds shown in FIG. 13 on the display section 296. In that case, the Ai center terminal 200 may display the related diseases or wounds extracted (retrieved) by the cause-of-death candidate retrieving section 250 and the cause-of-death candidates related to the cause of death on the display section 296.

In Step S111 (FIG. 6), the cause-of-death estimating section 260 (FIG. 3) estimates the direct cause of death of the patient and the original cause thereof based on the causality indicated by the extracted (retrieved) cause-of-death candidates. Specifically, the cause-of-death estimating section 260 rearranges the extracted (retrieved) cause-of-death candidates in chronological order and estimates the direct cause of death of the patient and the original cause thereof from the cause-of-death candidates rearranged in chronological order.

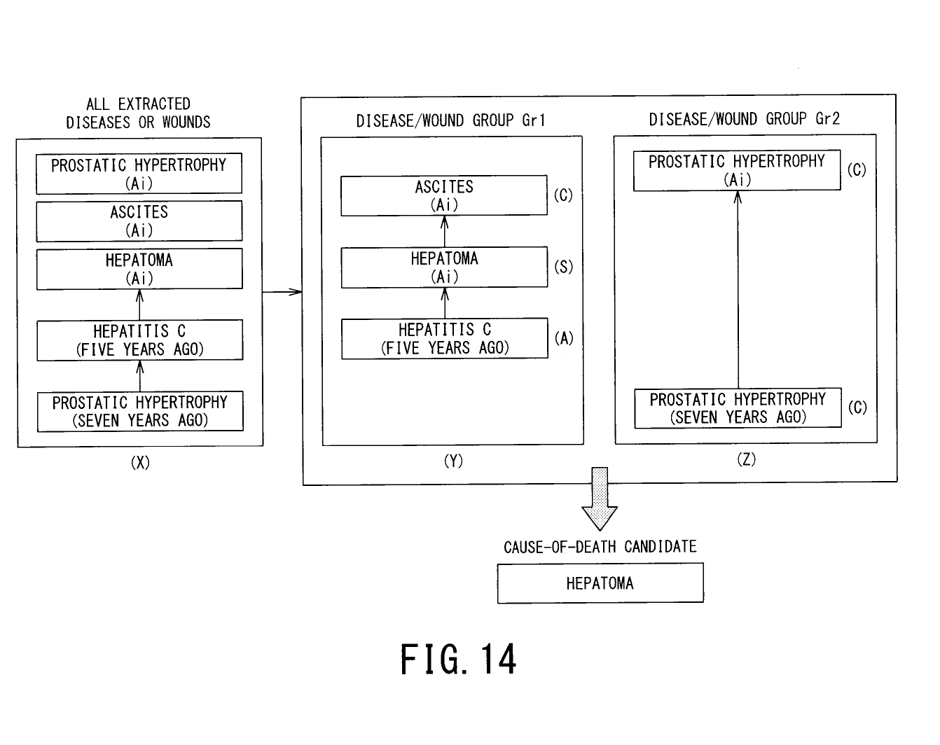

FIG. 14 is a diagram for illustrating how the cause-of-death estimating section 260 of the Ai center terminal 200 according to this embodiment rearranges the cause-of-death candidates in chronological order and estimates the direct cause of death of the patient and the original cause thereof from the cause-of-death candidates rearranged in chronological order.

As shown in Part (X) of FIG. 14, the cause-of-death estimating section 260 first rearranges all the extracted diseases and wounds in chronological order. As shown in Parts (Y) and (Z) of FIG. 14, the cause-of-death estimating section 260 then refers to the related disease/wound list stored in the disease/wound database 290, creates a relationship diagram, such as those shown in FIG. 13, and creates a disease/wound group of diseases or wounds according to the chronological order.

More specifically, a disease/wound group Gr1 is a group including “ascites (Ai)” and “hepatoma (Ai”), which are included in the diagnostic information of the Ai center terminal 200, and “hepatitis C (five years ago)”, which is included in the disease/wound history acquired from the hospital A. A disease/wound group Gr2 is a group including “prostatic hypertrophy (seven years ago)”, which is included in the disease/wound history acquired from the hospital A, and “prostatic hypertrophy (Ai)”, which is included in the diagnostic information of the Ai center terminal 200.

In particular, it is described that the prostatic hypertrophy included in the disease/wound group Gr2 occurred seven years ago and the patient still had the prostatic hypertrophy when the patient died. In this way, the cause-of-death estimating section 260 rearranges the diseases or wounds in chronological order based on the grouping of the diseases or wounds by the cause-of-death candidate retrieving section 250 based on the causality of the diseases or wounds, and estimates the direct cause of death of the patient and the original cause thereof from the rearranged cause-of-death candidates.

More specifically, in the example shown in FIG. 14, a severity rank ((S), (A) or (C), for example) is allocated to each disease or wound, and it is estimated that “hepatoma”, to which the S rank, which is the highest severity rank, is allocated, is the direct cause of death, and “hepatitis C five years ago” is the original cause of the direct cause of death.

“Ascites” is not the name of a disease or wound but the name of a symptom that a liquid is accumulated in an abdominal cavity, and is unlikely to be determined as a cause of death unlike “hemorrhagic shock”, which also is a symptom. Therefore, “ascites” is not appropriate for listing in the death certificate and is specified as “listing unnecessary” (FIG. 4).

In this embodiment, the disease/wound histories from the terminal 300 in the hospital A and the terminal 400 in the hospital B include no record of an operation. However, if there is information that the patient has ever received an operation for hepatoma, a statement of the operation has to be included in the death certificate because the operation is related to the disease or wound related to the cause of death.

In that case, for example, the disease/wound history acquiring section 240 may acquire a history including a statement of the operation for hepatoma from the terminal 300 in the hospital A, the cause-of-death candidate retrieving section 250 may extract hepatoma as a cause-of-death candidate related to the cause of death based on the history including the operation for hepatoma acquired from the terminal 300 in the hospital A, and the cause-of-death estimating section 260 may estimate that the operation for hepatoma is the direct cause of death.

The Ai center terminal 200 according to this embodiment may display the diagram for illustrating groups of diseases or wounds arranged in chronological order shown in FIG. 14 on the display section 296. In that case, the Ai center terminal 200 can display the cause-of-death candidates rearranged in chronological order by the cause-of-death estimating section 260 and the direct cause of death of the patient and the original cause thereof on the display section 296.

In Step S113 (FIG. 6), the death certificate template transmitting section 265 (FIG. 3) fills in the death certificate template used for creating a death certificate of the patient with the direct cause of death of the patient and the original cause thereof estimated by the cause-of-death estimating section 260 and the presence or absence of an operation for those diseases, and transmits the filled-in death certificate template to the outside.

The death certificate template transmitting section 265 is configured to transmit the death certificate template to the concerned hospital 500. However, this embodiment is not limited to the configuration. For example, the death certificate template may be transmitted to the Ministry of Health, Labour and Welfare that takes cause-of-death statistics, or to a police station, the hospital A or the hospital B depending on the incident or accident.

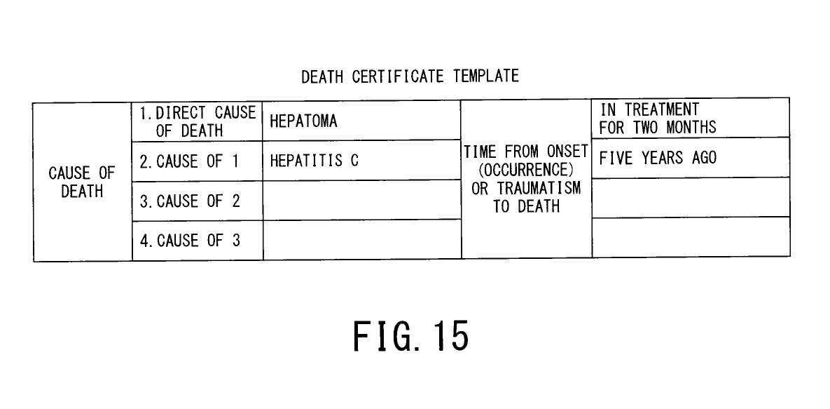

FIG. 15 is a diagram for illustrating a death certificate template used for creating a death certificate of the patient filled in with the estimated direct cause of death of the patient and original cause thereof by the death certificate template transmitting section 265 of the Ai center terminal 200 according to this embodiment.

As shown in FIG. 15, the death certificate template transmitting section 265 fills in the death certificate template with the cause-of-death candidate and original cause thereof estimated by the cause-of-death estimating section 260. Furthermore, since the related diseases or wounds are rearranged in chronological order, the times of occurrences of the direct cause of death and the original cause thereof can be grasped, and the times of occurrences of the direct cause and the original cause thereof can also be entered in the death certificate template.

More specifically, the entered direct cause of death is “hepatoma”, and the entered original cause of the “hepatoma” is “hepatitis C”. In addition, it is described that the hepatoma had been treated for two months, and it is also described based on the disease/wound history from the hospital A that the hepatitis C occurred five years ago.

The death certificate template transmitting section 265 is not limited to filling in the death certificate template with the cause-of-death candidate and original cause thereof estimated by the cause-of-death estimating section 260. For example, the death certificate template transmitting section 265 may further fill in the death certificate template with the name, the date of birth, the address at the time of death of the patient, for example.

As described above, the Ai center terminal 200 according to this embodiment acquires the result of interpretation (diagnostic information) by a radiologist at the Ai center and the disease/wound histories from other hospitals, such as the hospitals A and B. Based on the diagnostic information and the disease/wound histories, the Ai center terminal 200 searches the related disease/wound list in the disease/wound database 290, estimates a cause-of-death candidate and creates the death certificate template based on the cause-of-death candidate.

In this way, the Ai center terminal 200 according to this embodiment can accurately and specifically estimate the causes of death (the direct cause of death and the original cause thereof) and create the death certificate template. Therefore, if the radiologist or the doctor in charge of the patient's case at the Ai center terminal 200 approves the death certificate template, the death certificate template can be transmitted to the doctor in charge of the patient's case at the concerned hospital 500 or to a cause-of-death statistics organization of the Ministry of Health, Labour and Welfare.

The doctor or the like in charge of the patient's case at the concerned hospital 500 can more accurately grasp the direct cause of death and the original cause thereof based on the diagnostic information available from the Ai center and the disease/wound histories from the hospitals A and B or the like and therefore can precisely recognize the causality between the direct cause of death and the original cause thereof.

The Ai center terminal 200 according to this embodiment is configured to perform processings shown in FIGS. 13 and 14 according to an algorithm therein. However, the Ai center terminal 200 is not limited to the configuration. For example, the Ai center terminal 200 may be configured to display a relationship diagram of, or the causality among, diseases or wounds and the related diseases or wounds thereof on the display section 296 as required.

The Ai center terminal 200 according to this embodiment is not limited to the specific embodiment described above. For example, the Ai center terminal 200 may be used to collect information for “estimation of a cause of death” in “construction of an epidemiological database”, “study of grouping of diseases or wounds related to cancers” or the like.

Although a couple of embodiments of the invention are explained, these embodiments are exemplary only and it is not intended that the scope of the invention is limited by the embodiments. These embodiments can be put into practice in other various forms, and can be variously omitted, replaced or changed within the scope of the invention. The embodiments and their modifications are included in the scope and the coverage of the invention, and similarly in the equivalents to the claimed invention.

Also, in the embodiments of the present invention, the steps of flow charts show example processes that are performed in time-series in the order described, but they may also include processes that can be performed in parallel or independently rather than being performed in time-series.

What is claimed is:

1. A cause-of-death estimating apparatus, comprising:
a diagnostic information acquiring section configured to acquire diagnostic information on image data on a body;
a disease/wound history acquiring section configured to acquire a diagnosis/treatment history of the body before death of the body; and
a cause-of-death estimating section configured to estimate a direct cause of death of the body and an original cause thereof based on the acquired diagnostic information and the acquired diagnosis/treatment history.

2. The cause-of-death estimating apparatus according to claim 1, further comprising:
a cause-of-death candidate retrieving section configured to search a disease/wound database in which a disease or wound is registered based on the acquired diagnostic information and the acquired diagnosis/treatment history and retrieve a cause-of-death candidate related to the cause of death according to a degree of severity of the disease or wound,
wherein the cause-of-death estimating section
estimates the direct cause of death of the body and the original cause thereof based on a causality indicated by the retrieved cause-of-death candidate.

3. The cause-of-death estimating apparatus according to claim 2, wherein the cause-of-death candidate retrieving section
extracts a related disease or wound showing a degree of progress of the disease or wound from the disease/wound database based on the acquired diagnosis/treatment history and the acquired diagnostic information, and retrieves the cause-of-death candidate related to the cause of death based on the related disease or wound.

4. The cause-of-death estimating apparatus according to claim 2, wherein the cause-of-death estimating section
rearranges retrieved cause-of-death candidates in chronological order and estimates the direct cause of death of the body and the original cause thereof from the cause-of-death candidates rearranged in chronological order.

5. The cause-of-death estimating apparatus according to claim 1, further comprising:
a template transmitting section configured to fill in a death certificate template used for creating a death certificate of the body with the estimated direct cause of death of the body and the estimated original cause thereof and transmits the filled-in death certificate template to an outside.

6. The cause-of-death estimating apparatus according to claim 3, further comprising:
a display section,
wherein the cause-of-death candidate retrieving section
makes the display section display the extracted related disease or wound and the cause-of-death candidate related to the cause of death in a visually perceptible manner.

7. The cause-of-death estimating apparatus according to claim 4, further comprising:
a display section,
wherein the cause-of-death estimating section
makes the display section display the cause-of-death candidates rearranged in chronological order, the direct cause of death of the body and the original cause thereof.

8. The cause-of-death estimating apparatus according to claim 1, further comprising:
a disease/wound history requesting section configured to request a hospital for a disease/wound history registered with the hospital based on a treatment history related to the body before death,
wherein the disease/wound history acquiring section
acquires the disease/wound history as a diagnosis/treatment history of the body before death from a terminal in the hospital in which the requested disease/wound history is registered.

9. A cause-of-death estimating method performed by a cause-of-death estimating apparatus, the method comprising:
a diagnostic information acquisition step of acquiring diagnostic information on image data on a body;
a disease/wound history acquisition step of acquiring a diagnosis/treatment history of the body before death of the body; and
a cause-of-death estimation step of estimating a direct cause of death of the body and an original cause thereof based on the acquired diagnostic information and the acquired diagnosis/treatment history.

10. The cause-of-death estimating method performed by a cause-of-death estimating apparatus according to claim 9, the method further comprising:
a cause-of-death candidate retrieving step of searching a disease/wound database in which a disease or wound is registered based on the acquired diagnostic information and the acquired diagnosis/treatment history and retrieving a cause-of-death candidate related to the cause of death according to a degree of severity of the disease or wound,
wherein the cause-of-death estimating step includes
estimating the direct cause of death of the body and the original cause thereof based on a causality indicated by the retrieved cause-of-death candidate.
